(19) United States
(12) Patent Application Publication
(10) Pub. No.: US 2002/0150779 A1
(43) Pub. Date: Oct. 17, 2002

(54) Use of pet film as a barrier to bottom-up staining

(76) Inventors: Harry D. Ward, Lancaster, PA (US); Bruce E. Adams, Landisville, PA (US); William J. Kauffman, Manheim, PA (US); Eugene M. Kirchner, Maytown, PA (US); Thomas J. Moore, Lancaster, PA (US)

Correspondence Address: WOMBLE CARLYLE, SANDRIDGE & RICE, PLLC, Post Office Box 7037, Atlanta, GA, 30357-0037, US

(21) Appl. No.: 09/834,047

(22) Filed: Apr. 11, 2001

(51) Int. Cl. B32B 27/36

(52) U.S. Cl. 428/480; 428/483

(57) ABSTRACT

A flooring resistant to bottom-up staining is provided which includes a substrate; a polyethylene terephthalate (PET) barrier layer contacting the substrate; and a flooring structure in contact with the PET barrier layer. A method for manufacturing the flooring utilizing lamination processes is also provided.

### FIELD OF THE INVENTION

The present invention relates generally to floor coverings. In particular, the invention relates to a floor covering comprising a polyethylene terephthalate (PET) film as a barrier to bottom-up staining. The invention also relates to a method of manufacturing flooring with a PET film stain barrier.

### BACKGROUND

Bottom-up staining of flooring has been a constant problem for the flooring industry. Floor coverings presently used, such as vinyl flooring, are prone to staining from substances which migrate upward from a surface beneath the flooring. These substances may originate from the surface area of the subfloor, or from within the subfloor itself, and diffuse through the flooring to produce an undesirable stain visible to consumers. Such substances are referred to as “bottom-up” staining agents.

Examples of bottom-up staining agents include BHT (butylated hydroxytoluene)-containing oils, wood chemicals, the familiar purple plumbers primer, and biological stains resulting from fungi, molds, yeast, mildew and the like. Also, substances such as hair coloring may be spilled in areas adjacent to the flooring installation and migrate into the area underlying the flooring (e.g., a spill under a sink, where the substance travels to an area immediately adjacent to the flooring and underneath the flooring itself).

Attempts to provide solutions to bottom-up staining have included adding a polyamide or polyurethane layer in the floor. See U.S. Pat. Nos. 5,891,294 and 5,981,058 to Shih et al. (Shih). Shih provides the polyamide layer as a liquid coating while the polyurethane may be a coating or a film. Shih indicates that these layers may be used to prevent bottom-up staining or plasticizer migration from the plastisol part of the flooring structure into the high performance top coat. However, liquid coatings applied to porous substrates can have pinholes which will allow staining agents to migrate into the flooring structure. Additionally, these type coatings when applied to porous substrates tend to crack when the porous substrate is bent or cracked also allowing staining agents to migrate into the flooring structure. U.S. Pat. No. 5,460,855 to Andersson discusses a process for manufacturing floor and wall coverings having a barrier layer. The layer material provided is a polyvinyl chloride (PVC) plastisol that contains a dispersing agent and a water solution of sodium silicate.

The success of any product having a barrier layer to prevent bottom-up staining depends on several factors. First, it must be placed below the decorative layer of the flooring so that any coloration due to staining does not become apparent to the viewer. The layer must not prevent the flooring product from being flexible enough for reasonable handling during manufacture, storage, and installation. It must be able to be incorporated into a manufacturing process that allows costs to be controlled. Further, it must fully overcome the common problems of bottom-up staining by functioning well with materials which provide other desirable characteristics in popular flooring constructions. Current methods fail to provide a product which fully satisfies the foregoing criteria. Accordingly, a need exists for such flooring.

### SUMMARY OF THE INVENTION

The flooring of the present invention, and its method of manufacture, provide a solution to bottom-up staining in a flooring product which is effective in preventing stain migration, flexible without compromising the stain barrier, and which is manufactured by a commercially reasonable process.

Accordingly, in one aspect, the invention relates to a flooring component that provides resistant to bottom-up staining comprising a substrate; and a polyethylene terephthalate (PET) barrier layer.

In one aspect, the invention relates to a floor product resistant to bottom-up staining comprising a substrate; a flooring structure; and a polyethylene terephthalate (PET) barrier layer between the substrate and the flooring structure.

In another aspect, the invention relates to a floor product resistant to bottom-up staining comprising a substrate; a polyethylene terephthalate (PET) barrier layer; and a flooring structure in contact with the PET barrier layer. Preferably, the PET barrier layer is a film.

In another aspect, the invention relates to a floor product resistant to bottom-up staining comprising a substrate of porous felt material; a polyethylene terephthalate (PET) film barrier layer and comprising a heat sealable PET surface layer in contact with the substrate, a PET film, and a PET adhesion primer surface layer; and a flooring structure in contact with the adhesion primer surface layer of the PET barrier layer.

In another embodiment, the flooring structure further comprises a calendered polyvinyl chloride (PVC) basecoat, a foamable PVC plastisol in contact with the basecoat, a print design layer in contact with the foamable PVC plastisol, and a PVC clearcoat in contact with the design layer.

In yet another aspect, the invention relates to a method of manufacturing a floor product having resistance to bottom-up staining, the method comprising laminating a PET barrier layer film to a substrate; and attaching at least one further layer in contact with the PET barrier layer film.

In another embodiment, the invention relates to a method of manufacturing a floor product having resistance to bottom-up staining, the method comprising laminating a PET barrier layer film to the back-side of a preformed floor product.

In still another aspect, the invention relates to a method of manufacturing a floor product having resistance to bottom-up staining comprising laminating a PET barrier layer film to a substrate to form a substrate/PET film laminate; and laminating a calendered basecoat to a PET film side of said substrate/PET film laminate.

In still another aspect, the invention relates to a method of manufacturing a floor product having resistance to bottom-up staining comprising laminating a PET barrier layer film to a substrate; and attaching at least one further layer, wherein the laminating of the PET film to the substrate is completed during the attaching of the at least one further layer.

The present invention, and embodiments thereof, are described in more detail below. Although the present invention has been described with reference to certain embodiments, other embodiments may achieve similar results and advantages. Variations and modifications of the present invention will be apparent to one skilled in the art and the disclosure herein is intended to cover all such modifications and equivalents.

### BRIEF DESCRIPTION OF THE DRAWINGS

FIG. 1 is a cross-sectional view of an embodiment of the floor product of the present invention;

FIG. 2 is a schematic depiction of the roll and radiator arrangement of the feeds which accomplish lamination of the PET barrier layer film to a substrate in one embodiment of the invention.

FIG. 3 is a schematic depiction of the roll and radiator arrangement of feeds which may be used to accomplish lamination of a calendered basecoat to the PET/substrate laminate of the invention, or, alternatively, to accomplish lamination of the substrate, PET film, and the calendered basecoat in one operation.

### DETAILED DESCRIPTION OF THE INVENTION

The present invention provides a solution to the problem of bottom-up staining common to current types of flooring. Further, the polyethylene terephthalate (PET) film of the invention and the related manufacturing methods provide a barrier to bottom-up staining which is effective even in conjunction with porous or fibrous substrates such as felt. An additional benefit is that the flooring of the invention retains workability such that ease of handling and installation is not significantly impaired by addition of the barrier layer.

Accordingly, in one aspect the invention relates to a floor product resistant to bottom-up staining comprising a substrate; a PET barrier layer; and a flooring structure in contact with the substrate.

In another aspect the invention relates to a floor product resistant to bottom-up staining comprising a substrate; a PET barrier layer; and a flooring structure in contact with the PET barrier layer.

Substrates for flooring are well known in the art and include a solid, filled or unfilled polymeric layer or composite, a solid layer composite comprising a fibrous web saturated with polymeric binder, and porous fibrous layers such as beater saturated felts, and non-woven fabric materials.

Flooring structures are also well known in the art and can include single or multiple layers in the form of tile or sheet. They can also comprise solid and foam layers. They can be made from melt processing techniques, and in the case of PVC plastisols wet coating processing techniques can be employed. For this invention, flooring structures also means any single or multiple layer typically used in flooring products. The use of the substrate/PET composite structure with any flooring structure components, e.g. a foam and wear layer, produces a flooring product that is resistant to bottom-up staining and is considered to fall within the scope of the present invention. Therefore, the PET barrier layer film can be located on the back of the flooring product or contained with in the flooring product. In this fashion, the PET film stops migration of colored stains from the backside, before they can effect the product visually.

In one embodiment, the substrate comprises a PVC plastisol. In another embodiment, the substrate is a porous material. In an additional embodiment, the substrate is a felt.

In another aspect, the invention relates to a floor product resistant to bottom-up staining comprising a substrate; a PET barrier layer film contacting the substrate; and a flooring structure in contact with the PET barrier layer. To function as a flooring material, the PET barrier layer must adhere to the substrate as well as the flooring structure. Various adhesion primers and surface treatments can be used to gain adhesion and are selected based upon the substrate and flooring material. These can include multilayer extruded or laminated PET films, or PET films with adhesion primer coating layers.

In another embodiment, the adhesion primer surface layer is applied to the substrate and not the PET film. Subsequently, a PET film is laminated to the substrate/adhesion primer surface layer.

In one embodiment, the PET film further comprises a surface layer of heat sealable PET. The surface layer of heat sealable PET is in contact with a porous substrate. Additionally, the film further comprises an adhesion primer surface layer which is in contact with the flooring structure.

In another embodiment, the adhesion primer is selected from the group consisting of DUPONT TEIJIN FILMS' 822 primer, 453, HA8, and DP329.

In another embodiment, the flooring structure further comprises a calendered polyvinyl chloride (PVC) basecoat; a foamable PVC plastisol; a design layer, and a PVC clearcoat.

In yet another aspect, the invention relates to a floor product resistant to bottom-up staining comprising a substrate of porous felt material; a PET film barrier layer contacting the substrate, the PET barrier layer comprising a heat sealable PET surface layer in direct contact with the substrate, a PET layer, and an adhesion primer surface layer; and a flooring structure in contact with the adhesion primer surface layer of the PET barrier layer, the flooring structure comprising a calendered PVC basecoat in direct contact with the PET barrier layer, a foamable PVC plastisol in contact with the basecoat, a design layer in contact with the foamable PVC plastisol layer, and a PVC clearcoat in contact with the design layer.

In one embodiment, the invention relates to a method of manufacturing a floor product having resistance to bottom-up staining, the method comprising laminating a PET barrier layer film to the back-side of a preformed floor product.

In still another aspect, the invention relates to a method of manufacturing a flooring having resistance to bottom-up staining, the method comprising laminating a PET barrier layer film to a substrate; and attaching at least one further layer in contact with the PET barrier layer film.

In another embodiment, the method of manufacturing comprises moving the substrate using a first feed comprising rolls adapted to carry the substrate; and moving the PET film using a second feed comprising rolls adapted to carry the PET film, wherein the substrate and the PET film are transferred to contact one another against a heated drum. The temperature of the heated drum, dwell time, and the pressure applied to the substrate/PET film composite are adjusted to provide adhesion between the two layers after exiting the drum and cooling. The temperature of the heated drum can vary widely dependent upon the chemistry of the adhesion primer surface layer. For the materials described in the examples the drum temperature could be varied from 350° F. to 450° F. to gain adhesion. However, if other adhesion primer surface layers are utilized, temperatures lower than 350° F. can be employed. Temperatures higher than 450° F. can be employed if dwell time is short, the substrate can tolerate the temperature, and no detrimental physical changes occur to the PET barrier layer film. Additionally, pressures can also be varied significantly dependent upon drum temperature and adhesion primer surface layer. The higher the drum temperature the lower the pressure can be. For the examples described, the pressures were varied from 75 to over 220 lbs/square inch. Pressures can be lower than 75 and higher than 220 lbs/square inch dependent upon drum temperature and the chemistry of the adhesion primer surface layer.

In another embodiment, the substrate and the PET barrier layer film are preheated prior to contacting each other. The substrate is pre-heated utilizing a radiator disposed adjacent to a path of travel of the substrate prior to contact with PET film and the heated drum. The PET film is preheated utilizing a radiator disposed adjacent to a path of travel of the PET film where the PET film initially contacts the substrate and the heated drum.

In another embodiment, the substrate and the PET film move together in contact with the heated drum before reaching a pressure roll disposed against the heated drum.

In another embodiment, the at least one further layer is a calendered polyvinyl chloride (PVC) basecoat in contact with the PET barrier layer film, a foamable PVC plastisol in contact with the PVC basecoat, a print layer in contact with the foamable layer, and a PVC clearcoat in contact with the PVC plastisol.

According to the foregoing aspect, a substrate/PET film laminate is produced which provides the basis for construction of a flooring resistant to bottom-up staining. At least one further layer may be attached to the substrate/PET film laminate to provide a flooring structure, typically including a wear layer in the finished product. However, the present invention also provides further manufacturing processes for attaching at least one further layer by lamination. Two alternative methods are provided. In the first method, a calendered basecoat is applied to a completed substrate/PET film laminate. In the alternative method, the substrate, PET barrier layer film, and calendered basecoat are laminated in a single process.

Accordingly, in still another aspect, the invention relates to a method of manufacturing a flooring having resistance to bottom-up staining comprising laminating a PET film to a substrate to form a substrate/PET film laminate with good adhesion; and subsequently laminating a calendered basecoat to the PET film side of said substrate/PET film laminate. The calendered basecoat is generally a PVC basecoat as described in the examples, but other polymeric materials can be used, dependent upon the chemistry of the flooring structures selected.

In another embodiment, a substrate/PET film laminate with partial adhesion is moved into contact with a calendered basecoat such that the substrate/PET film laminate and the calender basecoat enter together between a bottom calender roll providing the calendered basecoat and a pressure roll. This produces good adhesion between the substrate/PET film as well as good adhesion between the calendered basecoat and the PET film as well.

In one embodiment, the substrate/PET film laminate is preheated using a radiator disposed adjacent to the PET film side of the substrate/PET film laminate feed in close proximity to a point of contact between the substrate/PET film laminate and the calendered basecoat. The substrate/PET film laminate is preheated to a temperature of from about 240° F. to about 270° F. in the examples described below. Higher temperatures can be employed dependent upon the substrate selected, but preheating may not be required dependent upon laminating drum conditions. In yet another embodiment, the method further comprises moving a substrate/PET film/calendered basecoat laminate over cooling rolls after lamination of the calendered basecoat between the bottom calender roll and the pressure roll.

As noted, the substrate, PET barrier layer film, and calendered basecoat may also be laminated together in a single process. Accordingly, in still another aspect, the invention relates to a method of manufacturing a flooring having resistance to bottom-up staining comprising laminating a PET barrier layer film to a substrate; and attaching at least one further layer, wherein the laminating of the PET film to the substrate is completed during the attaching of the at least one further layer.

In another embodiment, the method of manufacturing comprises moving the substrate using a first feed comprising rolls adapted to carry the substrate; and moving the PET film using a second feed comprising rolls adapted to carry the PET film, wherein the substrate and the PET film are transferred to a heated drum.

In another embodiment, the substrate and the PET film are pre-heated prior to contacting each other. The substrate is pre-heated utilizing a radiator disposed adjacent to a path of travel of the substrate prior to contact with the heated drum. Also, the PET film is preheated utilizing a radiator disposed adjacent to a path of travel of the PET film where the PET film initially contacts the heated drum.

In yet another embodiment, the substrate and the PET film move together in contact with the heated drum before reaching a pressure roll disposed against the heated drum.

A substrate/PET film which is partially laminated is produced prior to lamination of the calendered basecoat, in the sense that the substrate and PET film are not sufficiently attached to one another at this point. However, according to this aspect of the invention, sufficient adhesion between the PET film and the substrate is accomplished by carrying out the process for attaching a calendered basecoat.

Accordingly, in yet another embodiment, a resulting substrate/PET film laminate is moved into contact with a calendered basecoat such that the substrate/PET film laminate and the calender basecoat enter together between a bottom calender roll providing the calendered basecoat and a pressure roll. The substrate/PET film laminate is preheated using a radiator disposed adjacent to the substrate/PET film laminate feed in close proximity to a point of contact between the substrate/PET film laminate and the calendered basecoat. It should be noted that preheating may not be required depending upon the temperature of the drum, dwell time on the drum, and pressure applied.

In yet another embodiment, the substrate/PET film/calendered basecoat laminate is moved over cooling rolls after lamination of the calendered basecoat occurring between the bottom calender roll and the pressure roll.

It will be recognized that the present invention provides a method of manufacturing a substrate/PET film laminate with acceptable adhesion which allows for attaching at least one further layer in contact with the PET film.

Alternatively, the substrate/PET film laminate with good adhesion may be produced in a process which incorporates the attachment of the calendered basecoat.

Because the present invention utilizes a barrier layer film of PET, complete coverage of the flooring structure is obtained. Even if the flooring is bent enough to crack the substrate, e.g., during installation, the film will remain intact. Unlike a coating applied to the substrate which will crack when the flooring is bent, thereby compromising the stain barrier, the PET film of the present invention will remain an effective stain barrier even if the substrate is cracked. Also, liquid coatings applied to porous layers such as felt typically have pin holes generated by application of the coating to the porous layer. In contrast, the film of the present invention does not have such pinholes which may allow migration of staining agents to the top of the flooring.

In one embodiment of the present invention, a PET barrier layer film is laminated to a felt or plastisol substrate and a flooring structure is then built on this substrate/PET film laminate. The PET film may comprise three layers: a heat sealable PET surface layer (which is in contact with the substrate), a PET layer, and a surface adhesion primer layer. It is important is that the PET film layer have adequate adhesion to both the substrate and the flooring structure. The “heat sealable PET surface layer” is one class or type of a adhesion primer surface layer. Other adhesion primer surface layers can be employed to provide acceptable adhesion. Typically when used, the heat-sealable side of the PET film is in contact with the substrate, and a calendered PVC basecoat is either simultaneously or subsequently laminated to the surface adhesion primer side of the PET film. A foamable PVC plastisol is then applied and gelled, and a PVC clearcoat is then applied. Alternatively, other structures not utilizing the calendered layer can be made. For example the foamable plastisol can be applied directly to the PET film and a wearlayer also applied. Therefore, the PET film stain barrier is inserted in the flooring at a point where any stain migrating to the film from the bottom of the flooring will not reach a point where it would be visible at the top surface. A schematic representation of one embodiment of the flooring of the invention, as well as details of the manufacturing process according to one embodiment of the method of the invention, are described in more detail below.

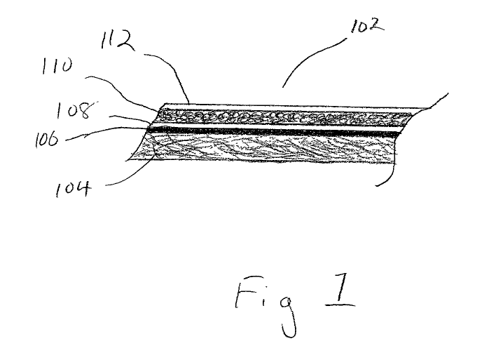

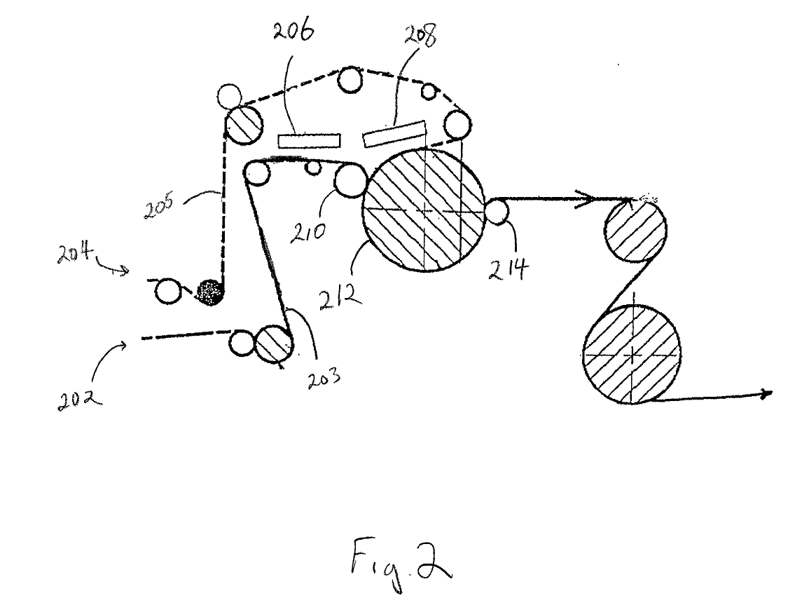

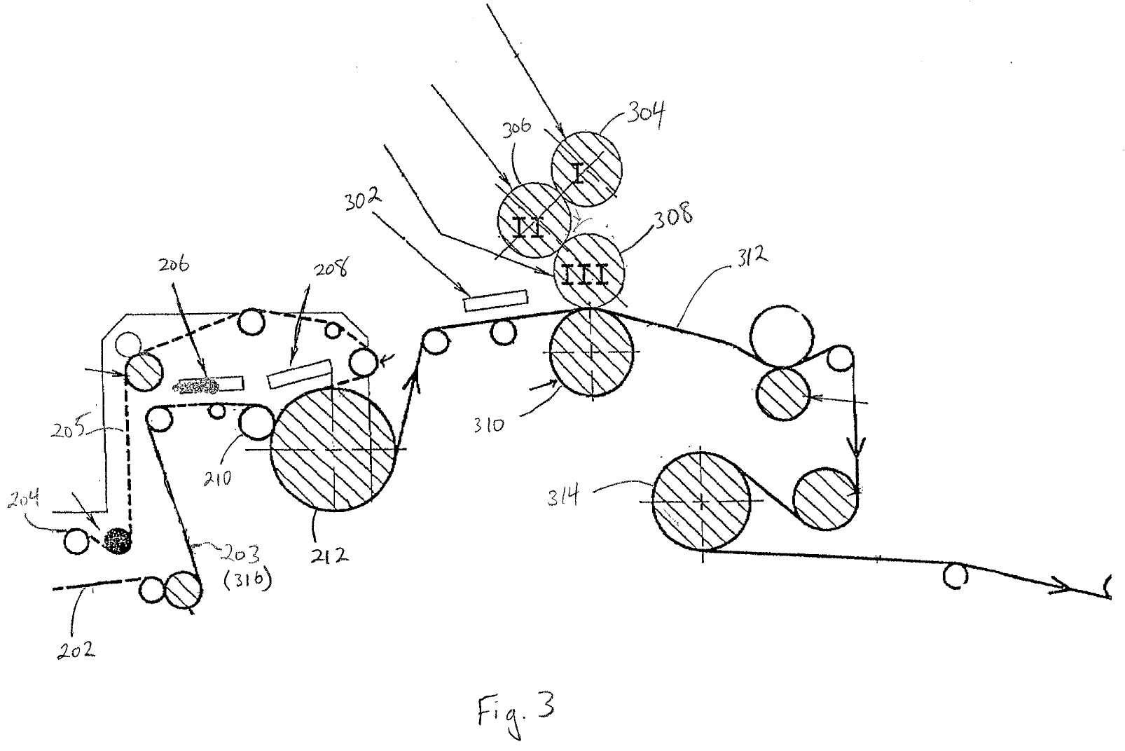

Referring to now to FIG. 1 showing a schematic drawing of a particular embodiment of the flooring of the invention, a typical flooring structure 102 is illustrated comprising a felt substrate 104, a polyethylene terephthalate (PET) film 106, a calendered PVC basecoat 108, a foamable PVC plastisol 110, and a PVC clearcoat 112. PET film 106 comprises a heat sealable PET layer, a regular PET layer, and a surface adhesion primer layer. The heat sealable layer of PET film 106 disposed to contact felt substrate 104, while the primer layer is disposed to contact calendered PVC basecoat 108. A primer which is particularly appropriate for the PET film of the invention is DUPONT TEIJIN FILM's 822 primer. Other possible primers include DUPONT TEIJIN FILM's 453, HA8, and DP329 primers. The felt substrate 104 may be separately laminated to PET film 106, followed by attachment of a calendered basecoat 108; or, alternatively, felt substrate 104, PET film 106, and calendered PVC basecoat 108 may be simultaneously laminated together. After construction of the foregoing layers, a foamable PVC plastisol layer 110 is applied and gelled using a heated drum. PVC clearcoat 112 is then added and the structure is subjected to conditions to expand the foamable PVC plastisol layer 110, and to fuse the two plastisols. Embodiments of the manufacturing method of the invention are schematically illustrated in FIGS. 2 and 3.

FIG. 2 shows a separate method for lamination of the substrate and PET film. Referring to FIG. 2, a first feed 202 supplies a felt substrate 203, while a second feed 204 supplies a PET film 205. PET film 205 comprises a heat sealable PET surface layer, a PET layer, and an adhesion primer surface layer. PET film 205 is supplied such that the heat sealable layer is oriented to contact felt substrate 203. First feed 202 carries felt substrate 203 past substrate radiator 206. Second feed carries PET film 205 past primary lamination radiator 208. PET film 205 and felt substrate 203 are brought into contact between roll 210 and oil-heated drum 212. Drum 212 is typically at a set temperature of 400° F. although it can be varied. Drum 212 can be polished steel or coated with TEFLON or similar material. After contacting one another, PET film 205 and felt substrate 203 are heated as they travel together around drum 212 before reaching pressure roll 214, which is typically set against drum 212 at 80 pounds per square inch (psi). The laminate is then cooled to room temperature, after which the PET film 205 and felt substrate 203 are unable to be separated without tearing of one or both layers. The temperature of the heated drum, dwell time, and the pressure applied to the substrate/PET film composite can be varied to provide adhesion between the two layers.

A calendered base coat is applied to the felt/PET film laminate resulting from the foregoing process. Referring now to FIG. 3, first feed 202 is utilized to convey the felt/PET film laminate (316) (in place of the felt substrate 203, which may also be conveyed via first feed 202). Second feed 204 is not utilized. The felt/PET laminate 316 is pre-heated to from about 240° F. to about 270° F. using pre-heating radiator 302. A melt layer of PVC is supplied to the calender (rolls 304, 306, and 308), and the calendered base coat is transferred from the bottom of roll 308 to the PET side of the felt/PET laminate between roll 308 and roll 310. The pressure between roll 308 and roll 310 is about 220 psi. After cooling to room temperature with the aid of cooling drum 314, the component layers of the felt/PET film/calendered layer laminate 312 are not able to be separated without tearing of the layers.

It also possible to laminate the PET film to the felt substrate and the calendered layer in one step. Referring again to FIG. 2, first feed 202 conveys the felt base layer 203, and second feed 204 conveys the PET film 205, as described above with respect to FIG. 2. However, oil-heated drum 212 is set to about 370° F. and has a surface temperature of about 350° F. At the point where PET film 205 and felt substrate 203 contact drum 212, a pressure roll 210 is provided which is set at 75 psi. Dwell time in contact with drum 212 after passing pressure roll 210 is about 4 seconds. The felt/PET bond is unacceptable at this point. However, after the laminate proceeds through the process of applying the calendered base coat, as described above, acceptable adhesion is achieved.

The felt/PET/calendered layer laminate is then incorporated into a flooring structure. Example 4 and 5 below describe construction and testing of one embodiment of the invention. Also see FIG. 1, and the description above of one embodiment of the flooring of the invention.

The following are intended to illustrate the invention and it is thought variations will occur to those skilled in the art. Accordingly, it is intended that the scope of the invention should be limited only by the appended claims.

### EXAMPLES

### Example 1

### Lamination of PET Film to Felt

A three layer PET film (heat seal PET, regular PET, primer; 0.48 or 0.60 mil) was laminated to the felt substrate (11 mil) using an oil-heated drum (set temperature of 400° F.), followed by a pressure roll (80 psi) as per FIG. 2. The PET film (second feed 204) with the heat sealable surface next to the felt (first feed 202) was brought into contact with a hot, TEFLON-coated drum, and heated for about 20 seconds before reaching the 80 psi pressure roll. After cooling to room temperature, attempts to separate the PET film and the felt resulted in tearing of the felt and film.

### Example 2

### Application of Calendered Basecoat

The calendered basecoat was applied (see FIG. 3) to the felt/PET laminate from Example 1 by preheating the laminate to 240-270° F. and then using pressure (220 psi) between roll 308 and roll 310 to transfer the calendered basecoat from the bottom roll of the calender to the felt/PET laminate as per FIG. 3. The felt/PET laminate was handled via first feed 202. After cooling to room temperature attempts to separate the PET film from the calendered layer resulted in tearing the layers. The heat seal PET was next to the felt and the primer side of the PET was next to the calendered layer.

### Example 3

### Lamination of Felt/PET Film/Calendered Basecoat in A Single Process

The lamination of all three layers was carried out in single process using the set-up of FIG. 3, by running the PET (second feed 204) and felt (first feed 202) around a heated drum (370° F. set temperature, 350° F. surface temperature; PET against the drum, heat sealable side against the felt). A pressure roll set at 75 psi was located at a point where both the PET and the felt contacted the drum. Dwell time in contact with the hot drum after the pressure roll was about 4 seconds. At this point the felt/PET bond was unacceptable. However, in the same operation, a calendered layer was applied as in Example 2 and acceptable adhesion between all three layers was achieved. The heat seal PET was next to the felt, and the primer side of the PET was next to the calendered layer.

### Example 4

### Incorporation of a Felt/PET/Basecoat Laminate into a Flooring Structure.

A foamable PVC plastisol was applied on top of the calendered basecoat and gelled by use of a 300° F. drum. A clearcoat PVC plastisol was then applied on top of the gelled foamable plastisol, and the structure was passed through an oven at the appropriate conditions to expand the foamable plastisol and fuse both plastisols.

### Example 5

### Stain Testing of the Flooring Structure Containing the PET Layer

A staining agent (6 drops of Clairol #80 hair dye) was applied to a ¼ inch luaun underlayment board and dried. The flooring structure of Example 4 and a control without a PET layer were each stapled to a luaun stained board and placed in a 160° F. oven. The samples were checked periodically for staining. The control showed a stain after 8 days whereas the structure with the PET layer did not stain after 30 days.

While specific embodiments have been set forth as illustrated and described above, it is recognized that variations may be made with respect to disclosed embodiments. Therefore, while the invention has been disclosed in various forms only, it will be obvious to those skilled in the art that many additions, deletions and modifications can be made without departing from the spirit and scope of this invention, and no undue limits should be imposed except as set forth in the following claims.

What is claimed is:

1. A floor product resistant to bottom-up staining comprising
a polyethylene terephthalate (PET) film layer located below a decorative layer.

2. A floor product or flooring component resistant to bottom-up staining comprising
a substrate; and
a polyethylene terephthalate (PET) film.

3. The floor product or flooring component of claim 2, wherein the substrate is selected from the group consisting of a solid polymeric layer, a solid polymer composite, a fibrous web saturated with a polymeric binder, and a porous layer.

4. The floor product or flooring component of claim 3, wherein the porous layer is a felt material.

5. The floor product or flooring component of claim 2, wherein the PET film further comprises at least one adhesion primer surface layer.

6. The floor product or flooring component of claim 2, wherein the PET film further comprises a surface adhesion layer of heat sealable PET.

7. The floor product or flooring component of claim 6, wherein the layer of heat sealable PET contacts the substrate.

8. The floor product or flooring component of claim 7, wherein the substrate is a porous material.

9. A floor product resistant to bottom-up staining comprising,
a substrate;
a flooring structure; and
a polyethylene terephthalate (PET) film interposed between said substrate and said flooring structure.

10. The floor product of claim 9, wherein the PET film comprises surface adhesion primer layers on both surfaces.

11. The floor product of claim 10, wherein one of the surface adhesion primer layers is a heat sealable surface layer in contact with the substrate, and the other adhesion primer surface layer in contact with the flooring structure.

12. The floor product of claim 11, wherein the adhesion primer surface layer that is in contact with the flooring structure is selected from the group consisting of DUPONT TEIJIN FILMS' 822 primer, 453, HA8, and DP329.

13. The floor product of claim 11, wherein the flooring structure comprises a calendered polyvinyl chloride (PVC) basecoat; a foamable PVC plastisol; a design layer; and a PVC clearcoat.

14. The floor product of claim 13, wherein the foamable PVC plastisol is in contact with the basecoat; the design layer is in contact with the foamable PVC plastisol; and the PVC clearcoat is in contact with the design layer.

15. A surface covering resistant to bottom-up staining comprising
a porous substrate; and
a polyethylene terephthalate (PET) film.

16. The surface covering of claim 15, wherein the PET film is in contact with the porous substrate.

17. The surface covering of claim 15, wherein an adhesion primer layer is interposed between the PET film and the porous substrate.

18. The surface covering of claim 15, wherein the porous substrate is a fibrous substrate.

19. The surface covering of claim 18, wherein the fibrous substrate is a felt substrate.

20. A floor product or flooring component resistant to bottom-up staining comprising
a felt substrate; and
a polyethylene terephthalate (PET) film.

21. A method of manufacturing a flooring component having resistance to bottom-up staining comprising
laminating a PET film to a substrate.

22. The method of claim 21, where the PET film further comprises at least one adhesion primer surface layer and said adhesion primer surface layer is adhered to the substrate.

23. The method of claim 22, wherein the adhesion primer surface layer is a heat sealable surface layer and said heat sealable surface layer is adhered to the substrate.

24. A method of manufacturing a floor product resistant to bottom-up staining comprising
laminating a PET film to a backside of a preformed flooring structure.

25. The method of claim 24, wherein the PET film comprises at least one adhesion primer surface layer and the adhesion primer surface layer is adhered to the preformed flooring structure.

26. A method of manufacturing a floor product resistant to bottom-up staining comprising
forming the flooring component of claim 2, and
constructing a flooring structure on one surface of the flooring component.

27. The method of claim 26, wherein the substrate and PET film are brought in contact with each other and heat and pressure are applied to the substrate and PET film using a heated drum and at least one pressure roll disposed against the drum.

28. The method of claim 27, wherein the substrate and the PET film are pre-heated prior to contacting each other.

29. The method of claim 27, wherein the substrate and the PET film are in contact with each other and the substrate/PET film laminate are in contact with the heated drum before reaching a pressure roll disposed against the heated drum.

30. The method of claim 26, wherein the flooring structure comprises a calendered basecoat and the calendered basecoat is adhered to the flooring structure.

31. The method of claim 30, wherein the calendered PVC basecoat is in contact with and adhered to the PET film, a foamable PVC plastisol is in contact with and adhered to the PVC basecoat, a design layer is in contact with and adhered to the PVC plastisol, and a PVC clearcoat is in contact with and adhered to the design layer.

32. The method of claim 30, wherein the substrate/PET film laminate is moved into contact with the calendered basecoat such that the substrate/PET film laminate and the calendered basecoat enter the nip between a bottom calender roll providing the calendered basecoat and a pressure roll together.

33. The method of claim 30, wherein the substrate/PET film laminate is preheated using a radiator disposed adjacent to the PET film side of the substrate/PET film laminate in close proximity to a point of contact between the substrate/PET film laminate and the calendered basecoat.

34. The method of claim 26, wherein the substrate is a porous felt and the PET film comprises a heat sealable PET and the porous felt is adhered to the heat sealable PET.

35. A method of manufacturing a floor product having resistance to bottom-up staining, said method comprising,
laminating a PET film to a substrate; and
adhering at least one further layer, wherein said laminating of said PET film to said substrate is completed to achieve acceptable adhesion during said adhering of said at least one further layer to said PET film/substrate laminate.
